(19) United States
(12) Patent Application Publication
(10) Pub. No.: US 2004/0010710 A1
(43) Pub. Date: Jan. 15, 2004

(54) Method and system for filtering requests to a web site

(76) Inventors: Wen-Hao Hsu, Taipei (TW); Chung-Chih Lin, Taipei (TW); Jui-Yu Hsu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/191,559

(22) Filed: Jul. 10, 2002

(51) Int. Cl. H04L 9/00

(52) U.S. Cl. 713/201

(57) ABSTRACT

The present invention provides a security control method to request access to a web site. The said method comprises: retrieving a URL (Uniform Resource Locator) from a request; verifying who sent the request and the user's identification. Next, obtaining the user's represented role, corresponding to the role of the user's authority for accessing a web site. Allowing access to the data stored in the web site depends on the authority granted to the individual user, wherein the data is the targeted resource, which is located by the URL.

### BACKGROUND OF THE INVENTION

1. Field of the Invention

This invention generally relates to the field of network security. More particularly, the present invention relates to a system and method for filtering requests to a web site, with the aim to control the level of authority, based on the individual user.

2. Description of the Prior Art

The main capability of the WWW (World Wide Web) is the support of HTML (Hypertext Markup Language) documents. An HTML document can include, but is not limited to, voice, animation, pictures, or a logic program. HTML documents that include various data types can be bound to each other through hyper links, that make up the network, providing the base for information and function. Therefore, the bound links insure the users can read the information on the WWW.

Accordingly, the usage of the Internet has been influenced by the WWW. The invention of a web browser allows users to read articles, which are on the Internet directly from a web browser. For various applications, distant learning can be reached through the Internet; customers can also shop using the Internet without any limitations regarding time and location. Therefore, the WWW is an important part of the Internet evolution, as we can broadly mention, the WWW is a kind of language with a specific behavior to provide access to information from network.

Therefore, the WWW not only provides text, audio, video, and even animation, but also operates as a client/server architecture. The client/server architecture includes a server side and a client side that connects to a network respectively, when a user sends out a client request to a server, the server will then generate a response back to the client. The approach that establishes such said architecture is called a “client-server network”. The above mentioned server is a computer usually used in the execution of the main managerial program that controls network access and the usage of resources. Thus providing the user needed information or data, just like a workstation, the server will have a higher capacity of storage and more hardware resources than a workstation.

Web servers use computers that process a client's request, to access an HTML web page. Opposite the web server is a client, which uses an application program called a web browser. When a user wants to browse a stored web page inside the web server, a web browser must be used. The client will send out a HTTP request (hypertext transport protocol request) to the web server, then the web server sends back a response to the client with the needed data.

The HTTP (hypertext transport protocol) is one of the protocols used on the WWW; the main feature of the HTTP is the capability to operate on different platforms, thus the data stored in different locations can be connected through Internet. During communication, one side executes an HTTP client program such as a web browser, while the other side executes the HTTP server program such as a web server.

However, in fact, many web sites provide different services, thus, it's needed to verify the user's identification, or control the user's authority when browsing specific web pages. The method of verification requires the user to input a preset account name and password to login on to a web site, but does not provide page level control for individual users access. If the existing web sites want to add the capability of secure control, it must modify substantially, or even reconstruct a new web site, which is inconvenient and will cost a lot of time and money for both the programmer and user.

Therefore, the present invention provides a security system and method, used to control and filter requests according to an individual user's authority without modifying the existent web site.

### SUMMARY OF THE INVENTION

According to the background of the invention mentioned above, and in accordance with the present invention, a system and method for filtering requests to a web site is provided, and used to overcome the disadvantages of the prior art.

Accordingly, one object of the present invention is to provide a filter before the web server receives the request and without modifying any data or codes of the web site.

Another object is to provide a capability of connecting the original variable used in the web site.

Another object is to provide a capability for setting a user's authority respectively.

Another object is to provide a capability of single file control, wherein the single file represents a resource under a web site.

Another object is filtering and detecting the parameters appended to a URL.

Another object is the ability to set the authority for a specific IP address.

According to the objects mentioned, the present invention provides a method for security control to a requested web site. The method comprises, first, the retrieval of a URL (Uniform Resource Locator) at a user's request. The verification of the user's identification is needed, and then the user's represented role is obtained corresponding to the user's authority for accessing the web site. The request to access the data stored in the web site depends upon authorization, wherein the data is the targeted resource which is located by the URL.

Accordingly, the present invention also provides a system for filtering and detecting a request before the web server receives the request. The system comprises a parser module, which is used to parse a request that includes a URL and an IP address. Secondly, a verify module that provides a sign in procedure which is used to identify users and user log in. Third, a role/group module, that a user has a corresponding role in this role/group module, and each user having their own role. Fourth, an authority control module, which is used to set up the individual role authority, wherein the authority represents the accessing level that, is permitted to the user. Besides, the roles with the same authority are congregated to form a group in the role/group module. Fifth, a connector module is used to connect the variables used in the web site for during parser module parsing.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is the diagram of system architecture of the present invention;

FIG. 2 is the preferred embodiment of the present invention; and

FIG. 3 is shown the flow chart of the present invention.

### DESCRIPTION OF THE PREFERRED EMBODIMENT

Some sample embodiments of the invention will now be described in greater detail. Nevertheless, it should be noted that the present invention can be practiced in a wide range of other embodiments besides those explicitly described, nor is the scope of the present invention expressly limited except as specified in the accompanying claims.

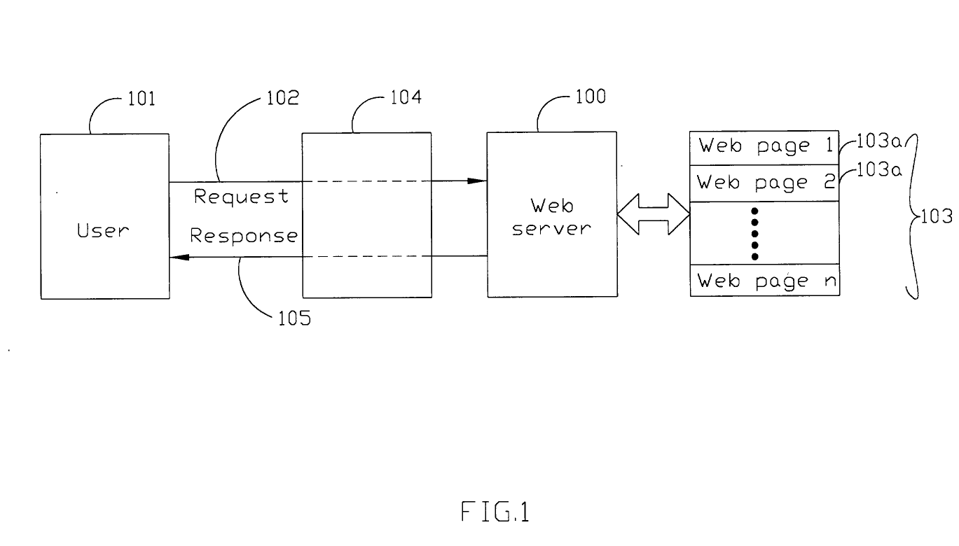

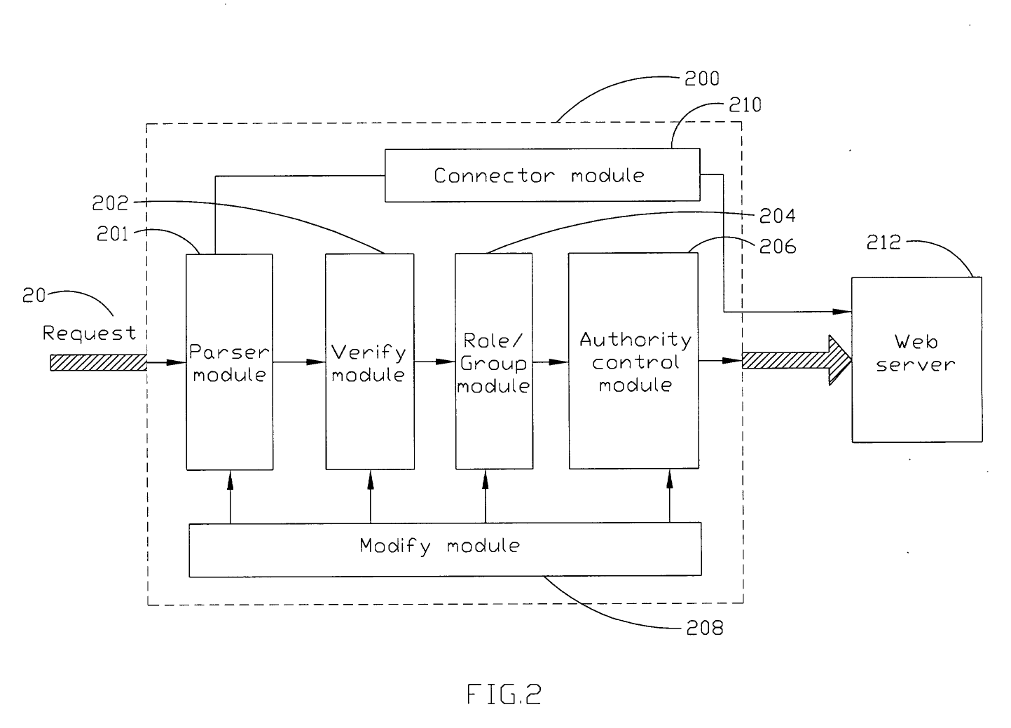

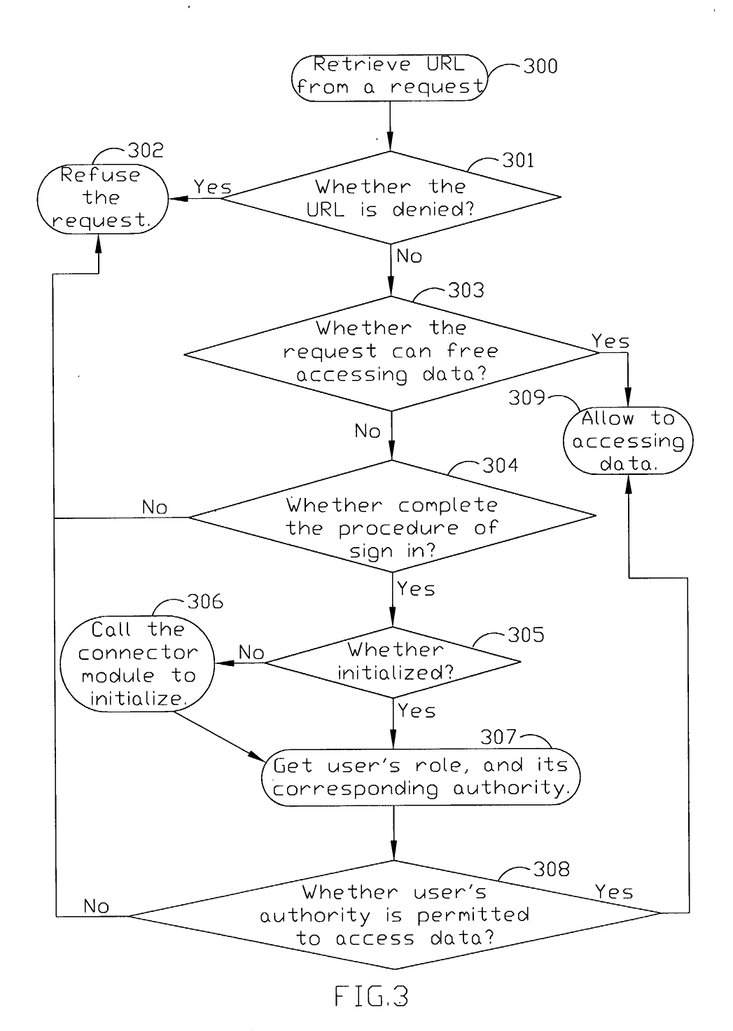

Furthermore, there are several figures used to illustrate the present invention in this preferred embodiment, thus, FIG. 1 is the diagram of a system architecture of the present invention; FIG. 2 is the preferred embodiment of the present invention; and FIG. 3 is the flow chart of the present invention.

The present invention contains a security control method used for detecting and filtering a request before a web server receives it. The present invention comprises the following method. First a URL (Uniform Resource Locator) is retrieved, and the user's identification is verified and the represented role is obtained. Corresponding to the access authority, a request is approved wherein the targeted resource data stored at the web site is located by the URL accordingly.

As shown in FIG. 1, the system architecture of the present invention uses the web server 100 to receive a request 102 sent by user 101. The security system 104 of the present invention will detect and filter the request 102 before web server 100 receives it. The request includes a URL (Uniform Resource Locator). The URL contains communication protocols used in the request, such as FTP (file transfer protocol), HTTP (hypertext transport protocol), Gopher or WAIS (wide area information servers). The system architecture and the preferred embodiment of the present invention are illustrated based on HTTP in WWW, but it isn't intended to be limited in scope of the implementation.

Generally, a URL is not only a standard expression used to indicate the position of an object, usually a web page on the Internet, but is also used as a format of address used in WWW. For HTML documents, a URL is further used to point out the hyperlink's linking destination. The said destination is used to represent another HTML document, which is probably stored on other computers.

As shown in FIG. 1, the request is allowed to access web pages 103 stored inside web server 100, and the web pages 103 are used to construct content and service of a web site. The web pages might be made up of HTML (hypertext markup language), ASP (active server page), or a JSP (Java server page), which are coded by different programming languages. Furthermore, web pages can be processed by various web servers on different platforms or operating systems, such as OS, Linux, or Window, etc.

As shown in FIG. 1, the web site security system 104 of the present invention receives the request 102 from user 101 before it reaches the web server 100, where the purpose of request 102 is accessing web page 103a. Then, after processing the request 102, security system 104 will permit request 102 to access the web page 103a based on the authority of user 10; and next, web server 100 generates a response 105 and send it back to user 101. If the security system 104 had detected request 102 without permission to access web page 103a, the security system 104 will notify user 101 that there is no right to access web page 103a.

Furthermore, respective users have their own permission. User 101 would require the account name and password to prove their identity the first time they wanted to browse a secured web site. Then security system 104 would permit the user to access a specific web page according to the user's respective permission until the user signs out. The user will be required to sign in again if they want to browse any secured data after sign out, and for safety purposes, the user also will be forced to sign out if there are not any interactions after a period of time.

FIG. 2 illustrates a preferred embodiment of the present invention, in which a web side security system 200 at least includes the following modules: a parser module 201, a verify module 202, a role/group module 204, an authority control module 206, a modify module 208, and a connector module 210.

The parser module 201 parses a request 20 when a request 20 with a URL is received. Then the URL, IP address (Internet Protocol address), and other parameters form this URL are retrieved. Wherein the IP address just like a computer's address on the Internet, that is represented in several adigitals, having the range of the number from 0 to 255, and being classified from A to E, at five levels.

Next, if a user didn't sign in at security system 200, then verify module 202 requires the user to proceed with the sign in procedure. The verify module 202 will keep the sign in data, rather than require the sign in procedure each time. Besides, the verify module 202 can pass or refuse the request from a specified IP address without identification.

The user who has been verified by the verify module 202 has a corresponding role in the role/group module 204, the role could be an independent role or a member of a group. And the roles that belong to the same group will have the same authority for easy administration. The authority control module 206 is used to set up the authority of each role and group in the security system 200, thus the security system 200 of the present invention can control each user's accessing permission according to their authority respectively. Furthermore, the present invention allows setting authority for the request form for a specific IP address.

The connector module 210 is used to retrieve the variables that a web site uses, and provides the variables for parser module 201 during parsing. Thus the parser module 201 can detect and filter the parameter, which are appended to a URL in advance to block the request with some specific variables.

Moreover, the modifier module 208 can be used, if necessary, to modify the data and parameters of the verify module 202, the role/group module 204, and the authority control module 206.

FIG. 3 illustrates a flow chart of the preferred embodiment of the present invention. Firstly a URL is retrieved from a request that is sent by a user (step 300). In general, the URL is not only a standard expression used to indicate an object's position, where the usual object is a web page on the Internet; but also it could be a format of an address used in WWW, or a HTML document that used a URL to point out the hyperlink's linking destination. The said destination is used to represent another HTML document that is probably stored on other computers.

Next, the system filters the URL request for access. If a URL denied (step 301) is determined necessary, due to a locked IP address, or any other non-specific condition, a request refused (in step 302) will be sent to notify the user.

When the URL request is accepted, the system will filter the user to the appropriate destination. If a free pass (step 303) is authorized, the request is forwarded to its destination, with direct access to the web pages. The user is free to access the data (step 309), without further inspections or other limitations. If a free pass (in step 303) is not granted, the filter system will require a sign-in procedure (step 304) to verify the user identification and variable initialization. A failure in log-in verification, during the sign-in procedure 304, will result in a request refused (step 302) to be sent to notify the user.

The next step in the URL filtering system is to determine whether the web sites need to initialize (step 305). The purpose of initialization is intended to link the variables of the web site used and those of each individual user. In general a web site usually utilizes several variables for operating purposes. One of the features of the present invention is to provide a system that offers secure control without modifying any existing codes. Thus, the system will filter and detect whether the web site is initialized, and when not initialized, call the connector module (in step 306) and link the variables.

After passing through the above steps, the users' role and corresponding authority is determined in step 307, judgment is based on the role or the group the user belongs to. If the user is authorized, an access to data 308 is sent. The system grants permission of access for each request according to their respective level of authority. The filter system of the present invention allows the access to data 309 and the users request for the resources can be retrieved as data or web pages.

Accordingly, the object of the present invention is to provide a filtering system without modifying existing codes, for web site access, with secure control and the capability of page level control, using the roles or groups to conveniently manage an individual user's authority.

Although specific embodiments have been illustrated and described, it will be obvious to those skilled in the art that various modifications may be made without departing from what is intended to be limited solely by the appended claims.

What is claimed is:

1. A method of security control for a request access a web site, said method comprising:
retrieving a URL (Uniform Resource Locator) from a request;
verifying an identification of a user who sent said request;
obtaining a represented role of said user;
getting said user's authority for accessing a web site corresponding the said role; and
allowing said request to access a data stored in said web site depend on said user's authority, wherein said data is the destination resource which is located by said URL.

2. The method according to claim 1, wherein said data includes at least a web page.

3. The method according to claim 1, further comprising retrieving an IP address (Internet Protocol address) from said request.

4. The method according to claim 3, further comprising locking at least a specific IP address, and refuse any requesting from said specific IP address.

5. The method according to claim 1, wherein verifying said user's identification requires said user to input an account name and a password.

6. The method according to claim 5, wherein said step of requiring said user to input an account name and a password is required only at first time user access said web site.

7. The method according to claim 1, further comprising setting the authority of a request that comes from a specific IP address.

8. A method for filtering a request to access a web page, said method comprising:
receiving a request, said request being a HTTP request (Hypertext Transport Protocol request);
verifying the identification of a user who sent said request;
obtaining the role of said user, wherein said role represents the authority for said user, and the roles have the same authority can be aggregated in a group; and
said request accessing a web page according to the authority of said user.

9. The method according to claim 8, further comprising sending a notice to an unverified user to proceed a procedure of sign in.

10. The method according to claim 8, further comprising locking a specific IP address, and then blocking any request that comes from said specific IP address to access any web page.

11. A system of security control for filtering a request access a web site, said system comprising:
a parser module used to parse a request with a URL and a IP address;
a verify module providing a procedure of sign in to verify identification of a user who sent said request;
a role/group module, said user having a corresponding role in said role/group module, and each user has their own role;
an authority control module used to set up the authority of individual role, wherein said authority represents the accessing level that is permitted to said user, roles with the same authority being congregated to form a group in said role/group module; and
a connector module use to connect variables that said web site used, and provides said variables for said parser module during parsing.

12. The system according to claim 11, further comprising a modify module used to modify the setting parameter of said parser module, said verify module, said role/group module, said authority control module, and said connector module.

13. The system according to claim 11, wherein said request that comes from a specific IP address is allowed to access said web site directly without any inspection by said system.

14. The system according to claim 11, wherein said request that comes from a specific IP address is blocked from accessing said web site.

15. The system according to claim 11, wherein said authority control module further set authority for a group so that the roles who re included in said group have the same authority.
